(19) United States
(12) Patent Application Publication
(10) Pub. No.: US 2013/0046961 A1
(43) Pub. Date: Feb. 21, 2013

(54) SPECULATIVE MEMORY WRITE IN A PIPELINED PROCESSOR

(71) Applicants: Alexander Rabinovitch, Kfar Yona (IL); Leonid Dubrovin, Karney Shomron (IL); Eran Dosh, Tel-Mond (IL); Noam Abda, Meitar (IL); Vered Antebi, Modiin (IL)

(72) Inventors: Alexander Rabinovitch, Kfar Yona (IL); Leonid Dubrovin, Karney Shomron (IL); Eran Dosh, Tel-Mond (IL); Noam Abda, Meitar (IL); Vered Antebi, Modiin (IL)

(21) Appl. No.: 13/209,681

(22) Filed: Aug. 15, 2011

(51) Int. Cl. G06F 9/38

(52) U.S. Cl. 712/216; 712/E09.062

(57) ABSTRACT

An apparatus generally having an interface circuit and a processor. The interface circuit may have a queue and a connection to a memory. The processor may have a pipeline. The processor is generally configured to (i) place an address in the queue in response to processing a first instruction in a first stage of the pipeline, (ii) generate a flag by processing a second instruction in a second stage of the pipeline, the second instruction may be processed in the second stage after the first instruction is processed in the first stage, and (iii) generate a signal based on the flag in a third stage of the pipeline. The third stage may be situated in the pipeline after the second stage. The interface circuit is generally configured to cancel the address from the queue without transferring the address to the memory in response to the signal having a disabled value.

### FIELD OF THE INVENTION

The present invention relates to pipelined processors generally and, more particularly, to a method and/or apparatus for implementing a speculative memory write in a pipelined processor.

### BACKGROUND OF THE INVENTION

Conventional pipelined processors issue a write memory address in an earlier stage in the pipeline than a later stage in which corresponding data is calculated and becomes ready to store in a memory. For a conditional memory write instruction, issuing the write memory address is dependent upon a condition and the condition is based upon the corresponding data. Therefore, pipeline interlocks are introduced to block the write memory address from issuing until the data is calculated. After the data is calculated, the condition is evaluated and the write memory address is issued only if the condition is true. The write memory address and the data are subsequently transferred to the memory. A number of stalls between the instruction that sets the resolution and the conditional memory write instruction is at least the number of stages between the earlier stage and the later stage. For software code with many conditions executing in the pipelined processor, the interlocks cause a severe performance reduction.

It would be desirable to implement a speculative memory write in the pipelined processor.

### SUMMARY OF THE INVENTION

The present invention concerns an apparatus having an interface circuit and a processor. The interface circuit may have a queue and a connection to a memory. The processor may have a pipeline. The processor is generally configured to (i) place an address in the queue in response to processing a first instruction in a first stage of the pipeline, (ii) generate a flag by processing a second instruction in a second stage of the pipeline, the second instruction may be processed in the second stage after the first instruction is processed in the first stage, and (iii) generate a signal based on the flag in a third stage of the pipeline. The third stage may be situated in the pipeline after the second stage. The interface circuit is generally configured to cancel the address from the queue without transferring the address to the memory in response to the signal having a disabled value.

The objects, features and advantages of the present invention include providing a method and/or apparatus for implementing a speculative memory write in a pipelined processor that may (i) perform a speculative execution of memory write instructions, (ii) store the speculative write memory addresses in a write queue, (iii) proceed with the memory transaction where a condition is evaluated to be true, (iv) cancel the memory transaction where the condition is evaluated to be false and/or (v) operate in a pipelined processor.

### BRIEF DESCRIPTION OF THE DRAWINGS

These and other objects, features and advantages of the present invention will be apparent from the following detailed description and the appended claims and drawings in which:

FIG. 1 is a block diagram of an apparatus in accordance with a preferred embodiment of the present invention;

FIG. 2 is a block diagram of an example pipeline;

FIG. 3 is a diagram of a portion of an example flow of a speculative execution of a memory write instruction;

FIG. 4 is a diagram of example flows of instructions X, Y and Z; and

FIG. 5 is a flow diagram of an example method illustrating the executions in an execute stage and a write back stage of the pipeline.

### DETAILED DESCRIPTION OF THE PREFERRED EMBODIMENTS

Some embodiments of the present invention generally provide a speculative execution of memory write instructions in a pipelined processor. The pipelined processor generally has some or all of the following characteristics. The processor may use several pipeline stages. The stages may be arranged in a certain sequence (e.g., issue read/write address, load data, execute and store data). The write memory address generated by a conditional memory write instruction may be stored in a write queue (or other type of storage). The write queue generally buffers one or more of the write memory addresses until the corresponding write data is available. A resolution for a conditional execution may be determined in the execute stage. If the condition resolution results in a false value, the conditional write to the memory may be canceled before the write memory address is transferred from the write queue to the memory. If the condition resolution results in a true value, the write memory address and the data may be transferred to the memory.

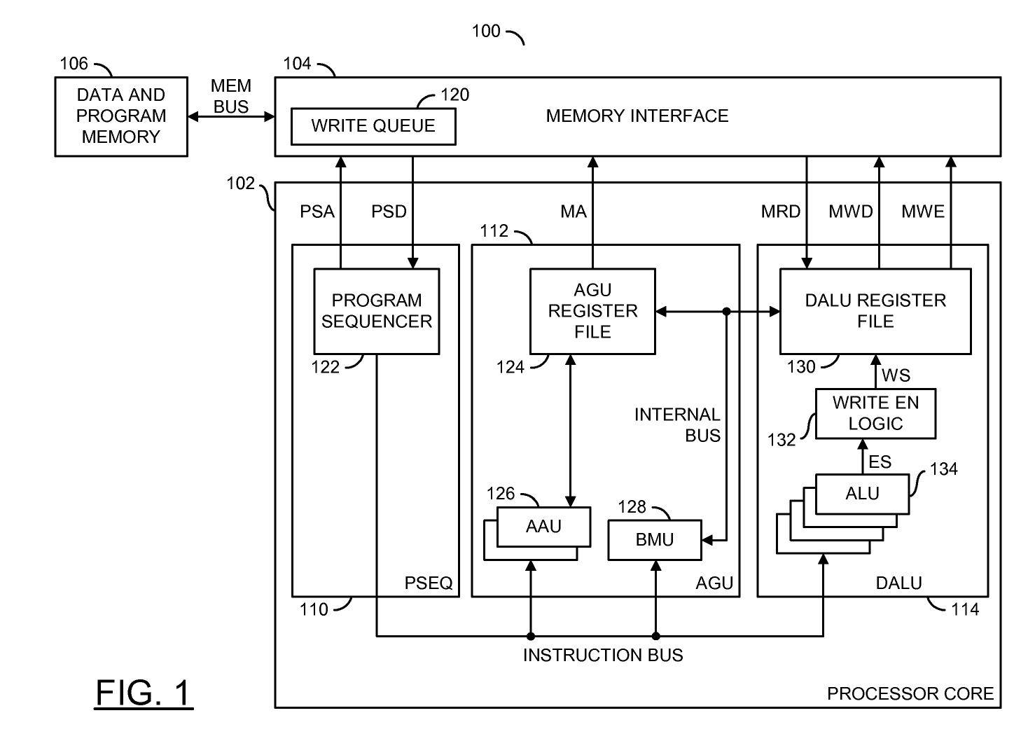

Referring to FIG. 1, a block diagram of an apparatus 100 is shown in accordance with a preferred embodiment of the present invention. The apparatus (or circuit or device or integrated circuit) 100 may implement a pipelined processor with a speculative execution of memory write instructions. The apparatus 100 generally comprises a block (or circuit) 102, a block (or circuit) 104 and a block (or circuit) 106. The circuit 102 generally comprises a block (or circuit) 110, a block (or circuit) 112 and a block (or circuit) 114. The circuit 104 generally comprises a block (or circuit) 120. The circuit 110 generally comprises a block (or circuit) 122. The circuit 112 generally comprises a block (or circuit) 124, one or more blocks (or circuits) 126 and a block (or circuit) 128. The circuit 114 generally comprises a block (or circuit) 130, a block (or circuit) 132 and one or more blocks (or circuits) 134. The circuits 102-134 may represent modules and/or blocks that may be implemented as hardware, software, a combination of hardware and software, or other implementations. In some embodiments, the circuit 104 may be part of the circuit 102.

A bus (e.g., MEM BUS) may connect the circuit 104 and the circuit 106. A program sequence address signal (e.g., PSA) may be generated by the circuit 122 and transferred to the circuit 104. The circuit 104 may generate and transfer a program sequence data signal (e.g., PSD) to the circuit 122. A memory address signal (e.g., MA) may be generated by the circuit 124 and transferred to the circuit 104. The circuit 104 may generate a memory read data signal (e.g., MRD) received by the circuit 130. A memory write data signal (e.g., MWD) may be generated by the circuit 130 and transferred to the circuit 104. The circuit 130 may also generate a memory write enable signal (e.g., MWE) which is received by the circuit 104. A write signal (e.g., WS) may be generated by the circuit 132 and presented to the circuit 130. The circuit 134 may generate an enable signal (e.g., ES) which is received by the circuit 132. A bus (e.g., INTERNAL BUS) may connect the circuits 124, 128 and 130. A bus (e.g., INSTRUCTION BUS) may connect the circuits 122, 126, 128 and 134.

The circuit 102 may implement a pipelined processor. The circuit 102 is generally operational to execute (or process) instructions received from the circuit 106. Data consumed by and generated by the instructions may also be read (or loaded) from the circuit 106 and written (or stored) to the circuit 106. The pipeline within the circuit 102 may implement a software pipeline. In some embodiments, the pipeline may implement a hardware pipeline. In other embodiments, the pipeline may implement a combined hardware and software pipeline.

The circuit 102 is generally configured to (i) place an address in the circuit 120 in response to processing a given instruction in a given stage of the pipeline, (ii) generate a flag (e.g., an asserted state in the signal ES) by processing another instruction in another stage of the pipeline and (iii) generate the signal MWE based on the flag in yet a later stage of the pipeline. The pipeline may be arranged with the other stage occurring between the given stage and the later stage. The arrangement of the stages may cause the other instruction to be processed in the other stage after the given instruction is processed in the given stage such that the issuance of a conditional write memory address from the given stage may take place before the condition is resolved in the other stage.

The circuit 104 may implement a memory interface circuit. The circuit 104 may be operational to buffer one or more write memory addresses in the circuit 120 and communicate with the circuit 106. For speculate memory access, the circuit 104 may be configured to cancel a corresponding write memory address from the circuit 120 in response to the signal MWE having a disabled value (or level). The canceled write memory address may not be transferred to the circuit 106. The circuit 104 may also be operational to transfer the write memory address from the circuit 120 to the circuit 106 in response to the signal MWE having an enabled value (or level). Transfer of the enabled write memory address and corresponding data generally stores the corresponding data in the circuit 106 at the write memory address.

The circuit 106 may implement a memory circuit. The circuit 106 is generally operational to store both data and instructions used by and generated by the circuit 102. In some embodiments, the circuit 106 may be implemented as two or more circuits with some storing the data and others storing the instructions.

The circuit 110 may implement a program sequencer (e.g., PSEQ) circuit. The circuit 110 is generally operational to generate a sequence of addresses in the signal PSA for the instructions executed by the circuit 100. The addresses may be presented to the circuit 104 and subsequently to the circuit 106. The instructions may be returned to the circuit 110 from the circuit 106 through the circuit 104 in the signal PSD.

The circuit 112 may implement an address generation unit (e.g., AGU) circuit. The circuit 112 is generally operational to generate addresses for both load and store operations performed by the circuit 100. The addresses may be issued to the circuit 104 via the signal MA.

The circuit 114 may implement a data arithmetic logic unit (e.g., DALU) circuit. The circuit 114 is generally operational to perform core processing of data based on the instructions read fetched by the circuit 110. The circuit 114 may receive (e.g., load) data from the circuit 106 through the circuit 104 via the signal MRD. Data may be written to (e.g., stored) through the circuit 104 to the circuit 106 via the signal MWD. The circuit 114 may also be operational to generate the signal MWE in response to a resolution of a conditional write to the circuit 106. The signal MWE may be generated in an enabled state (or logic level) where the condition is true. The signal MWE may be generated in a disabled state (or logic level) where the condition is false.

The circuit 120 may implement a write queue circuit. The circuit 120 is generally operational to buffer one or more write memory addresses and the corresponding data. The write memory addresses and the data may be transferred from the circuit 120 to the circuit 106 for unconditional store operations. For conditional store operations, transfer or cancellation of the write memory address and the corresponding data is generally in response to the state of the signal MWE.

The circuit 122 may implement a program sequencer circuit. The circuit is generally operational to prefetch a set of one or more addresses by driving the signal PSA. The prefetch generally enables memory read processes by the circuit 104 at the requested addresses. While an address is being issued to the circuit 106, the circuit 112 may update a fetch counter for a next program memory read. Issuing the requested address from the circuit 104 to the circuit 106 may occur in parallel to the circuit 122 updating the fetch counter.

The circuit 124 may implement an AGU register file circuit. The circuit 124 may be operational to buffer one or more addresses generated by the circuits 126 and 128. The addresses may be presented by the circuit 124 to the circuit 104 via the signal MA.

The circuit 126 may implement one or more (e.g., two) address arithmetic unit (e.g., AAU) circuits. Each circuit 126 may be operational to perform address register modifications. Several addressing modes may modify the selected address registers within the circuit 124 in a read-modify-write fashion. An address register is generally read, the contents modified by an associated modulo arithmetic operation, and the modified address is written back into the address register from the circuit 126.

The circuit 128 may implement a bit-mask unit (e.g., BMU) circuit. The circuit 128 is generally operational to perform multiple bit-mask operations. The bit-mask operations generally include, but are not limited to, setting one or more bits, clearing one or more bits and testing one or more bits in a destination according to an immediate mask operand.

The circuit 130 may implement a DALU register file circuit. The circuit 130 may be operational to buffer multiple data items received from the circuits 106, 128, 132 and 134. The read data may be receive from the circuit 106 through the circuit 104 via the signal MRD. The signal MWD may be used to transfer the write data to the circuit 106 via the circuit 104. An enable indication may be received by the circuit 130 from the circuit 132 via the signal WS. The circuit 130 may transfer the enable indication in the signal MWE to the circuit 104.

The circuit 132 may implement a write enable logic circuit. The circuit 132 is generally operational to generate the enable indication in the signal WS based on the resolution of a condition. The signal WS may be asserted in the enable state (or logic level) where the condition is true. The signal WS may be asserted in the disable state (or logic level) where the condition is false. The true/false results of the condition resolution may be received by the circuit 132 from the circuit 134 via the signal ES.

The circuit 134 may implement one or more (e.g., four) arithmetic logic unit (e.g., ALU) circuits. Each circuit 134 may be operational to perform a variety of arithmetic operations on the data stored in the circuit 130. The arithmetic operations may include, but are not limited to, addition, subtraction, shifting and logical operations. At least one of the circuits 134 may be operational to generate a flag value in the signal ES based on the resolution of a condition. The flag value may have a true (or logical one) state where the condition is true. The flag value may have a false (or logical zero) state where the condition is false.

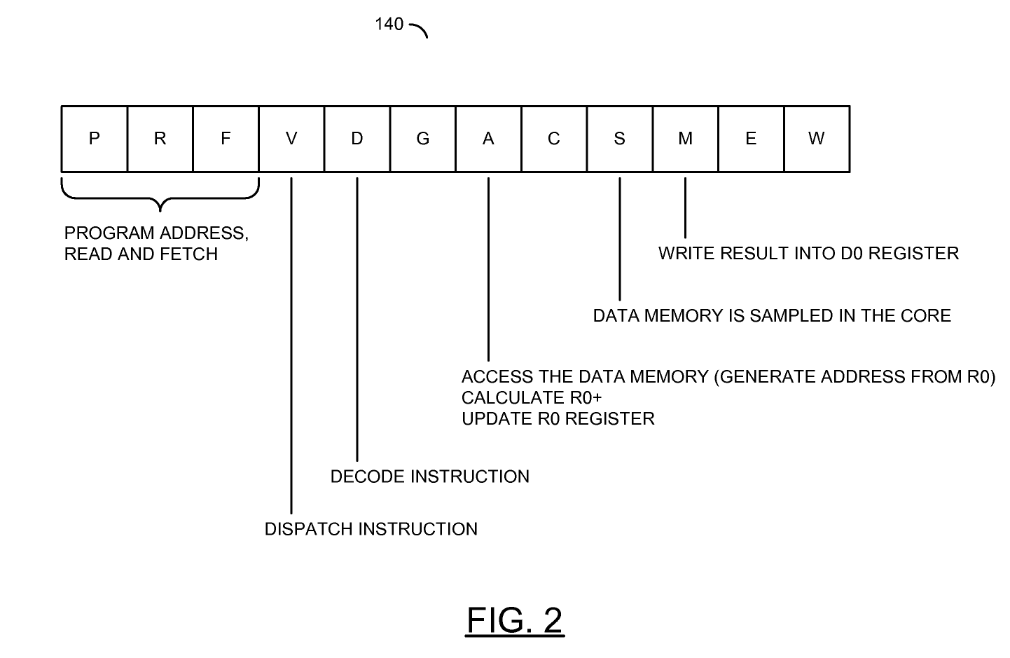

Referring to FIG. 2, a block diagram of an example pipeline 140 is shown. The pipeline 140 generally comprises multiple stages (e.g., P, R, F, V, D, G, A, C, S, M, E and W). The pipeline may be implemented by the circuits 102 and 104.

The stage P may implement a program address stage. During the stage P, the fetch set of addresses may be driven via the signal PSA along with a read strobe (e.g., a prefetch operation) by the circuit 122. Driving the address onto the signal PSA may enable the memory read process. While the address is being issued from the circuit 104 to the circuit 106, the stage P may update the fetch counter for the next program memory read.

The stage R may implement a read memory stage. In the stage R, the circuit 104 may access the circuit 106 for program instructions. The access may occur via the memory bus.

The stage F may implement a fetch stage. During the stage F, the circuit 104 generally sends the instruction set to the circuit 102. The circuit 102 may write the instruction set to local registers in the circuit 110.

The stage V may implement a variable-length execution set (e.g., VLES) dispatch stage. During the stage V, the circuit 110 may displace the VLES instructions to the different execution units via the instruction bus. The circuit 110 may also decode the prefix instructions in the stage V.

The stage D may implement a decode stage. During the stage D, the circuit 102 may decode the instructions in the different execution units (e.g., 110-114).

The stage G may implement a generate address stage. During the stage G, the circuit 110 may precalculate a stack pointer and a program counter. The circuit 112 may generate a next address for both one or more data address (for load and for store) operations and a program address (e.g., change of flow) operation.

The stage A may implement an address to memory stage. During the stage A, the circuit 124 may send the data address to the circuit 104 via the signal MA. The circuit 112 may also process arithmetic instructions, logic instructions and/or bit-masking instructions (or operations).

The stage C may implement an access memory stage. During the stage C, the circuit 104 may access the data portion of the circuit 106 for load (read) operations. The requested data may be transferred from the circuit 106 to the circuit 104 during the stage C.

The stage S may implement a sample memory stage. During the stage S, the circuit 104 may send the requested data to the circuit 130 via the signal MDR.

The stage M may implement a multiply stage. During the stage M, the circuit 114 may process and distribute the read data now buffered in the circuit 130. The circuit 134 may perform an initial portion of a multiply-and-accumulate execution. The circuit 102 may also move data between the registers during the stage M.

The stage E may implement an execute stage. During the stage E, the circuit 134 may complete another portion of any multiply-and-accumulate execution already in progress. The circuit 114 may complete any bit-field operations still in progress. The circuit 134 may complete any ALU operations in progress. Furthermore, the circuit 132 may perform the write enable operation.

The stage W may implement a write back stage. During the stage W, the circuit 114 may return any write data generated in the earlier stages from the circuit 130 to the circuit 104 via the signal MWD. The enable information may also be presented from the circuit 130 to the circuit 104 via the signal MWE. Once the circuit 104 has received the write memory address, the write data and the signal MWE from the circuit 102, the circuit 104 may either execute the write (store) operation where the signal MWE is true or cancel the write operation where the signal MWE is false. Execution of the write operation may take one or more processor cycles, depending on the design of the circuit 100.

By way of example, FIG. 2 includes legends for a simple store instruction (e.g., Move I(R0)+, D0). During the stages P, R and F, the circuits 102-106 may issue a program fetch then read and fetch the requested store instruction from the circuit 106 to the circuit 102. During the stage V, the store instruction may be dispatched. In the stage D, the store instruction may be decoded. During the stage A, access to the data may be initiated with a read address issued from a register (e.g., register R0) to the circuit 104. A next read address (e.g., R0+) may be calculated and stored in the register R0. In the stage S, the requested data may be sampled into the circuit 130. During the stage M, results may be written into the identified register D0.

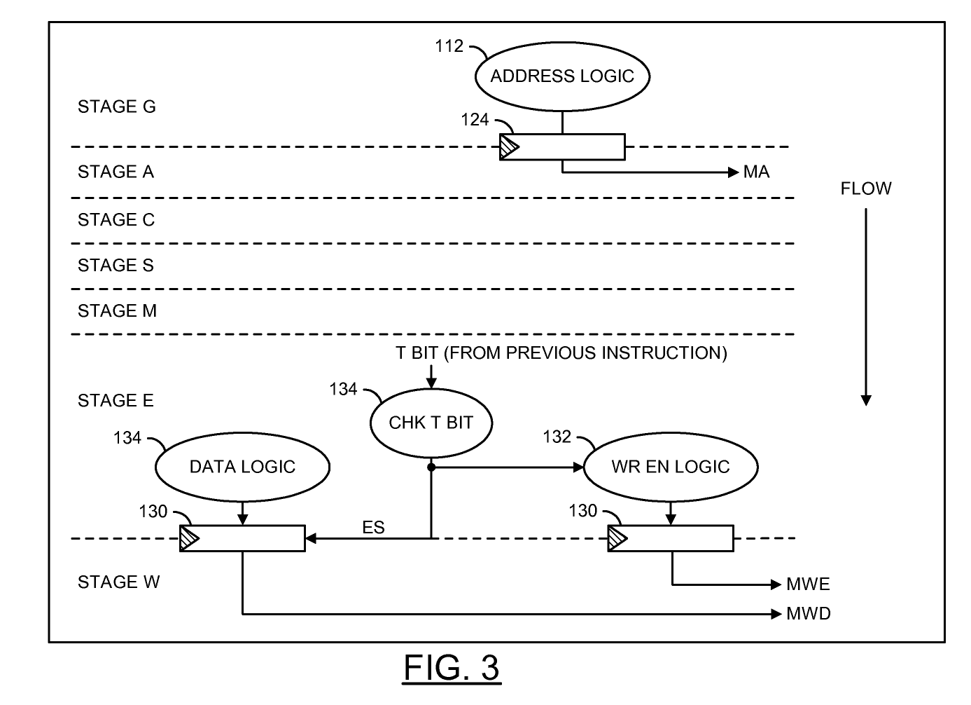

Referring to FIG. 3, a diagram of a portion of an example flow of a speculative execution of a memory write instruction is shown. The example flow is illustrated from the stage G to the stage W of the pipeline 140. An example set of instructions (e.g., X, Y and Z) may be used in the illustration as follows:

. . .

instruction X: add D0,D1 ; modifies a value D1 by adding a value D0.

instruction Y: cmpgth D1,D2 ; compares the value D1 with a value D2.

instruction Z: ift move.l D1, (R0); if the results of the comparison (e.g., T) made in previous instruction was TRUE, store the new value D1 to the memory address stored in register R0.

. . .

The instruction sequence above is generally executed by the pipeline 140 in the following way:

instruction X: add—performed by the data logic of the circuit 134 and stored in the circuit 130 in the stage E.

instruction Y: cmpgth—performed by the check T bit of the circuit 134 in the stage E. The circuit 132 may also generate the enable information and store the enable information in the circuit 130 in the stage E.

instruction Z: ift move.l—performed by the circuit 112 and stored in the circuit 124 in the stage G. In the stage A, the address may be sent from the circuit 124 to the circuit 120 via the signal MA. The circuit 120 generally allocates space for the corresponding data that should be written at the stage W.

During the stage W, the data may be transferred from the circuit 130 to the circuit 120 via the signal MWD. The enable signal may be transferred via the signal MWE from the circuit 130 to the circuit 104.

The distance between stages A and E is generally four stages in the example. For a conventional pipeline design, four interlocked cycles are introduced between instruction Y and instruction Z. Hence, the sequence should take three cycle for the instructions plus four cycles for the stalls, resulting in a total of seven cycles.

In some embodiments of the present invention, the instruction Z may be speculatively executed in the stage A. Allocation of the write memory address and the corresponding data in the circuit 120 during the stage A may allow the circuit 104 to hold the address until the condition is resolved. The enable signal may be updated in the stage E once the condition is known. Thereafter, the circuit 104 may either finish with the condition store instruction if the enable signal is true (or correct). If the speculation was false (or wrong), the write memory address and the corresponding data buffered in the circuit 120 may be discarded. Neither the canceled address nor the canceled data may be sent out from the circuit 120 to the circuit 106. Using the technique of speculative memory write instruction execution, the sequence of instructions X, Y and Z may take only three cycles instead of the seven cycles.

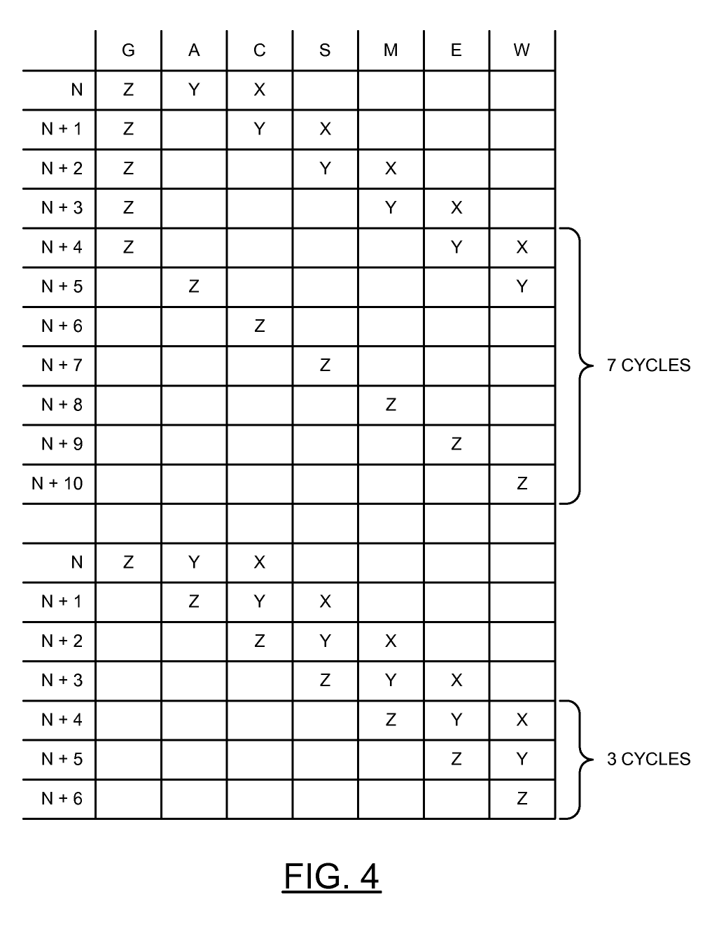

Referring to FIG. 4, a diagram of example flows of the instructions X, Y and Z is shown. The top set generally illustrates the flow of the instructions without using the speculative write technique. The bottom set may illustrate the flow of the instructions using the speculative write technique.

During a cycle N, the instruction X, Y and Z may be executed in the stages C, A and G respectively. Without the speculative write technique (top flow), the instructions X and Y may continue through the stages S, M, E and W while the instruction Z is stalled at the stage G. Alternatively, four non-operation instructions may be placed between the instruction Y and the instruction Z. After the condition has been resolved by executing the instruction Y in the stage E in the cycle N+4, the instruction Z may be allowed to continue through the stages A to W in the cycles N+5 to N+10. Because of the stalls (or non-operation instructions), the instruction X may be separated by the instruction Z by seven cycles at the stage W.

Implementing the speculative write (bottom flow) generally causes the conditional write memory address to be issued to the circuit 120 during the execution of the instruction Z in the stage A in the cycle N+1. Thus, the instruction Z may continue through the stages behind the instruction Y without any stalls during the remaining cycles N+2 to N+6. After the condition has been resolved by executing the instruction Y in the stage E in the cycle N+4, the circuit 104 may take the appropriate action either to finish the conditional store or cancel the conditional store. As a result, the instruction X may be separated by the instruction Z by three cycles during all of the stages.

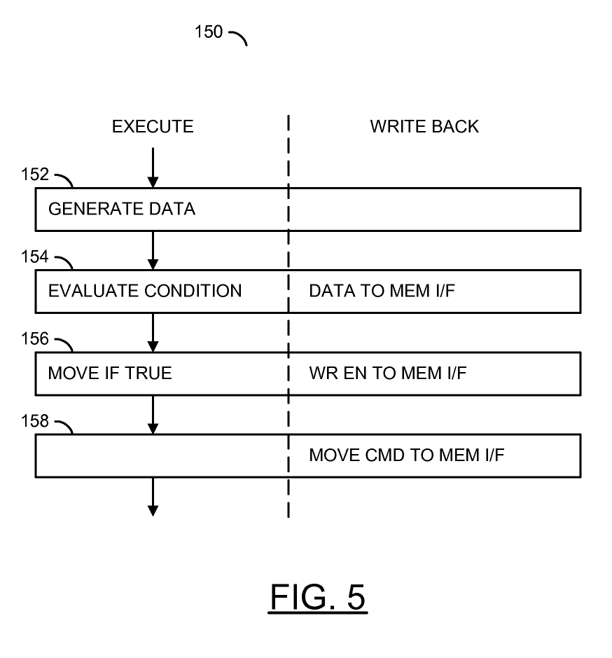

Referring to FIG. 5, a flow diagram of an example method 150 illustrating the executions in the stages E and W is shown. The method (or process) 150 may be implemented in the circuit 100. The method 150 generally comprises a step (or state) 152, a step (or state) 154, a step (or state) 156 and a step (or state) 158. The steps 152-158 may represent modules and/or blocks that may be implemented as hardware, software, a combination of hardware and software, or other implementations.

In the step 152, the data may be generated by executing the instruction X in the stage E. Evaluation of the condition may be performed in the step 154 by executing the instruction Y in the stage E. During the step 154, the instruction X may be executed in the stage W causing the data to be moved to the circuit 120. In the step 156, the instruction Z may be executed in the stage E. The signal MWE indicating the resolution of the condition may be generated in the stage W during the step 156. In the step 158, the instruction Z may be executed in the stage W. The execution of the instruction Z in the stage W may cause the circuit 102 to issue a move command to the circuit 104. The circuit 104 may subsequently either continue with the move (store) operation if the signal MWE is true. If the signal MWE is false, the circuit 104 may cancel the move operation.

The functions performed by the diagrams of FIGS. 1-5 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

As would be apparent to those skilled in the relevant art(s), the signals illustrated in FIGS. 1 and 3 represent logical data flows. The logical data flows are generally representative of physical data transferred between the respective blocks by, for example, address, data, and control signals and/or busses. The system represented by the circuit 100 may be implemented in hardware, software or a combination of hardware and software according to the teachings of the present disclosure, as would be apparent to those skilled in the relevant art(s).

While the invention has been particularly shown and described with reference to the preferred embodiments thereof, it will be understood by those skilled in the art that various changes in form and details may be made without departing from the scope of the invention.

1. An apparatus comprising:
an interface circuit having a queue and a connection to a memory; and
a processor having a pipeline, said processor is configured to (i) place an address in said queue in response to processing a first instruction in a first stage of said pipeline, (ii) generate a flag by processing a second instruction in a second stage of said pipeline, wherein said second instruction is processed in said second stage after said first instruction is processed in said first stage, and (iii) generate a signal based on said flag in a third stage of said pipeline, wherein said third stage is situated in said pipeline after said second stage, and said interface circuit is configured to cancel said address from said queue without transferring said address to said memory in response to said signal having a disabled value.

2. The apparatus according to claim 1, wherein said interface circuit is further configured to write to said memory at said address in response to said signal having an enabled value.

3. The apparatus according to claim 1, wherein at least one other stage is situated in said pipeline between said first stage and said second stage.

4. The apparatus according to claim 1, wherein (i) said second stage comprises an execute stage and (ii) said third stage comprises a write back stage.

5. The apparatus according to claim 1, wherein said first instruction is not stalled in said pipeline while said second instruction advances from said first stage to said third stage.

6. The apparatus according to claim 1, wherein said processor is further configured to generate data in said second stage before said second instruction reaches said second stage.

7. The apparatus according to claim 1, wherein said processor is further configured to transfer data from said third stage to said queue.

8. The apparatus according to claim 7, wherein said interface circuit is configured to transfer said data from said queue to said memory in response to said signal having an enable value.

9. The apparatus according to claim 1, wherein said first instruction is not separated from said second instruction in said pipeline by one or more non-operational instructions.

10. The apparatus according to claim 1, wherein said apparatus is implemented as one or more integrated circuits.

11. A method for a speculative memory write in a pipeline of a processor, comprising the steps of:
(A) placing an address in a queue in response to processing a first instruction in a first stage of said pipeline;
(B) generating a flag by processing a second instruction in a second stage of said pipeline, wherein said second instruction is processed in said second stage after said first instruction is processed in said first stage;
(C) generating a signal based on said flag in a third stage of said pipeline, wherein said third stage is situated in said pipeline after said second stage; and
(D) canceling said address from said queue without transferring said address to a memory in response to said signal having a disabled value.

12. The method according to claim 11, further comprising the step of:
writing to said memory at said address in response to said signal having an enabled value.

13. The method according to claim 11, wherein at least one other stage is situated in said pipeline between said first stage and said second stage.

14. The method according to claim 11, wherein (i) said second stage comprises an execute stage and (ii) said third stage comprises a write back stage.

15. The method according to claim 11, wherein said first instruction is not stalled in said pipeline while said second instruction advances from said first stage to said third stage.

16. The method according to claim 11, further comprising the step of:
generating data in said second stage before said second instruction reaches said second stage.

17. The method according to claim 11, further comprising the step of:
transferring data from said third stage to said queue.

18. The method according to claim 17, further comprising the step of:
transferring said data from said queue to said memory in response to said signal having an enable value.

19. The method according to claim 11, wherein said first instruction is not separated from said second instruction in said pipeline by one or more non-operational instructions.

20. An apparatus comprising:
means for placing an address in a queue in response to processing a first instruction in a first stage of a pipeline;
means for generating a flag by processing a second instruction in a second stage of said pipeline, wherein said second instruction is processed in said second stage after said first instruction is processed in said first stage;
means for generating a signal based on said flag in a third stage of said pipeline, wherein said third stage is situated in said pipeline after said second stage; and
means for canceling said address from said queue without transferring said address to a memory in response to said signal having a disabled value.
